(19) United States
(12) Patent Application Publication
(10) Pub. No.: US 2010/0028837 A1
(43) Pub. Date: Feb. 4, 2010

(54) FLIGHT MOTION SIMULATOR

(76) Inventor: George E. Holloway, Penticton (CA)

Correspondence Address: Antony C. Edwards, 200-270 Highway 33W, Kelowna, British Cloumbia, CA

(21) Appl. No.: 12/448,086

(22) PCT Filed: Dec. 7, 2007
(86) PCT No.: PCT/CA2007/002202

§ 371 Date: Jun. 8, 2009

Related U.S. Application Data
(60) Provisional application No. 60/873,585, filed on Dec. 8, 2006.

(30) Foreign Application Priority Data
Dec. 8, 2006 (CA) 2570845

(51) Int. Cl. G09B 9/12; G05G 9/047; A63G 31/16

(52) U.S. Cl. 434/30; 434/59; 472/130

(57) ABSTRACT

A flight motion simulator includes a pitch frame pivotably mounted, and nested for pitching in a roll frame. The roll frame is pivotally mounted to, and nested for rolling in, a base frame. The roll frame and pitch frame are rotatable in unison so as to simulate a roll of an aircraft relative to the base frame. The pitch frame is rotatable relative to the roll frame so as to simulate a pitch of the aircraft relative to the roll frame. A control stick is pivotably mounted to the base frame and pitch frame for controlling and actuating the pitch and roll. A first coupler having at least two degrees of freedom is rotatably mounted to the lower end of the control stick and to the pitch frame. A second coupler also having at least two degrees of freedom is rotatably mounted to the control stick at a lower mid-section thereof to an upper end of a post mounted to the base frame. This aids the pilot in actuating pitch and roll as the control stick provides mechanical advantage to the pilot providing manual inputs to the upper end of the control stick. The two degrees of freedom of the first and second couplers include rotation about a longitudinal axis and rotation about a lateral axis.

### FIELD OF THE INVENTION

This invention relates to the field of flight motion simulators and in particular to a two axis of motion passive flight motion simulator.

### BACKGROUND OF THE INVENTION

It is known in the prior art to provide flight simulators for the training of pilots. These may be basic instrument simulators or may be for example full motion simulators such as used for training airline pilots, fighter pilots and the like wherein the simulators physically move with a yoke or control stick input from the pilot and are designed to immerse the pilot in a simulated flying environment. Such prior art flight motion simulators may be either active or passive, the latter active type typically being actuated by for example hydraulic actuators controlled by computer flight simulator programs. The former passive flight motion simulators move in direct response to motions of the control stick input by the pilot wherein the motion of the control stick provides a mechanical leverage to move the pilot with respect to a fixed frame of reference so as to simulate the motion of an aircraft in flight.

A two axis passive flight similar referred to as A JoyRider™ flight Simulator is described at the www.acesim.com website The JoyRider™ is described as based on a balanced gimbal system along the centre of gravity axis for pitch and roll wherein the pilot sitting in the JoyRider™ is suspended in a cockpit high enough to clear a stand and allowed enough room for the ranges of motion, presumably the range of motion available for both pitch and roll.

The JoyRider™ Flight Simulator is described as being made of PVC pipe, wood or metal. The cockpit is described as having rails supporting a seat apparently for rotation of the cockpit about pitch pivot points which are taught to coincide with the centre of gravity of the combined cockpit and pilot when sitting in the seat.

A rectangular gimbal frame is provided outside of the cockpit frame that attaches to the cockpit frame at the pitch pivot points. The gimbal frame connects to a base at roll pivot points. The roll pivot points are taught to be the front and rear, centred on the cockpit frame. One embodiment of the base is disclosed as a rectangular wooden box having triangular uprights at the front and rear of the base, and alternatively the base is disclosed to be a rectangular welded steel tubing base having steel tubing uprights extending vertically upwards at either end of the rectangular base. The gimbal frame is mounted to the upper ends of either the triangular uprights or the vertical steel uprights at the roll pivot points on the front and back of the gimbal frame.

A passive control system is described as including a centre stick mounted as one to the cockpit and at the opposite end to the lower most end of a control stick. The control stick extends upwardly between the knees of the pilot, just forward of the front edge of the seat. The control stick is pivotally mounted to a rigid control stick base connection which is mounted to the lower most frame of the base. The control stick base connection is illustrated to include an inverted “Y” shaped member wherein the ends of the arms of the Y are mounted to the base and is allowed to pivot up and down slightly with pitch. The opposite end of the Y, that is, the end of the single leg of the Y is pivotally mounted approximately mid way along the length of the control stick by a bracket which provides pivoting in both pitch and roll. Similarly, the lower most end of the control stick is mounted to the centre stick by a bracket which provides for pivoting in both pitch and roll. The centre stick is illustrated to be a V shaped member rigidly mounted to the cockpit.

According to the provided illustrations of the JoyRider™ apparently a pilot when seated in the cockpit seat and pulling back on the upper end of the control stick, rotates the control stick about the upper end of a control stick base connection mounted to the base so as to drive the lower most end of the control stick forwardly this elevates the forward end of the cockpit frame by the upward force exerted by the lower end of the control stick on a control stick support brace mounted between the lower end of the control stick and the forward end of the cockpit frame. Elevating the forward end of the cockpit frame pitches the cockpit frame up about the pitch pivots moving the control stick oppositely, that is, pushing it forwards, pitches the cockpit frame down about the pitch points.

The pilot moving the upper end of the control stick side to side again rotates the control stick about the upper end of the control stick base connection, that is, about the bracket mounted at the upper end thereof thereby swinging the control stick support brace side to side in a direction opposite to the movement of the upper end of the control stick. The side to side motion imparted to the control stick support brace is transmitted to the cockpit frame and then to the gimbal frame via the pitch pivots causing the gimbal frame to rotate relative to the base about the roll pivots.

### SUMMARY OF THE INVENTION

In summary, the flight simulator according to one aspect of the present invention may be characterized as including a pitch frame pivotally mounted to and nested for pitching in a roll frame wherein the roll frame is pivotally mounted to and nested for rolling in a base frame. The base frame has the roll frame and pitch frame are rotatable in unison so as to simulate a roll of an aircraft relative to said base frame. The pitch frame is rotatable relative to the roll frame so as to simulate a pitch of said aircraft relative to the roll frame. The base frame has upwardly extending, longitudinally opposite fore and aft ends and a base member extending therebetween. The roll frame has opposite fore and aft ends and elevated sides extending therebetween. The roll frame is rotatably mounted to said fore and aft ends of said base frame for rotation about an elevated longitudinally extending first axis of rotation elevated on upper ends of the longitudinally opposite fore and aft ends of the base. The pitch frame has opposite fore and aft ends and is rotatably mounted to the roll frame for rotation about an elevated, laterally extending second axis of rotation on said elevated sides. The first axis of rotation is orthogonal to said second axis of rotation.

A seat is rigidly mounted to the aft end of the pitch frame so as to face towards said fore end of said pitch frame. The second axis of rotation is located forward of the seat and substantially medially along a longitudinal length of the pitch frame. A first plane of symmetry is coincident with the first axis of rotation and is orthogonal to the second axis of rotation. The first plane of symmetry substantially bisects the seat, the pitch frame and the roll frame.

A rigid post is rigidly mounted to, and extends upwardly from the base member adjacent a forward end of the seat. The post lies substantially in the first plane of symmetry.

A rigid control stick having opposite upper and lower ends is pivotably mounted to the base frame and the pitch frame for controlling and actuating the pitch and roll. A first coupler having at least two degrees of freedom is rotatably mounted to the lower end of the control stick and to the pitch frame. A second coupler also having at least two degrees of freedom is rotatably mounted to the control stick at lower mid-section thereof, between the upper and lower ends of the control stick, to an upper end of the post. An upper length of the control stick extends from the lower mid-section to the upper end of the control stick. The upper length is longer than a lower length of the control stick extending from the lower mid-section to the lower end of the control stick. Thus a first lever arm provided by the upper length of the control stick is longer than a second lever arm provided by the lower length. This aids the pilot in actuating pitch and roll as it provides mechanical advantage to the pilot providing the manual inputs to the upper end of the control stick. The upper end of the control stick extends above a lower portion of the seat on which the pilot sits so that the control stick is within reach of the pilot sitting in the seat and so as to extend between the pilot's legs. The two degrees of freedom of the first and second couplers include rotation about a longitudinal axis and rotation about a lateral axis.

A mount is provided for mounting rudder pedals or the like in the fore end of the pitch frame. The pedals are positioned in the fore end of the pitch frame for placement of the pilot's feet thereon when the pilot is sitting in the seat.

Pitch and roll output means for example a backwardly mounted joystick, is provided cooperating with the seat and with the pitch frame and roll frame for communicating to a flight simulation processor pitch and roll data corresponding to pitch and roll orientation of the pitch and roll frames respectively relative to the base frame.

In one embodiment the roll frame may include a spaced apart, longitudinally extending parallel first pair of rails extending along opposite sides of the seat. The first pair of rails have opposite forward and rearward ends. A forward crossbar may extend laterally across and between the first pair of rails so as to join the forward ends of the first pair of rails. A rear cross bar may extend laterally across and between the first pair of rails so as to join the rearward ends of the first pair of rails thereby forming a continuous frame. The first axis of rotation intersects the forward and rearward cross bars substantially orthogonally and substantially medially laterally across the cross bars.

A rearward portion of the first pair of rails may form the elevated sides of the roll frame. A forward portion of the first pair of rails may be lower than the rearward portion to provide for ease of access of the pilot getting into or out of the pitch frame. The control stick protrudes upwardly from between the forward portion of the first pair of rails. The forward cross bar extends upwardly from the forward portion of the first pair of rails so as to intersect the first axis of rotation. The pitch frame may include a spaced apart, longitudinally extending, parallel second pair of rails extending along the opposite sides of the seat and rotatably suspended under the rearward portion of the first pair of rails.

The fore and aft ends of the base frame may include a pair of upstanding elongate members disposed substantially in the first plane of symmetry.

The first coupler may be a rigid first link member. The first degree of freedom of the first link is the rotation of the link about a longitudinal axis, wherein the longitudinal axis lies in the first plane of symmetry. The second degree of freedom is rotation of the first link about lateral axes, and in particular rotation of the first link relative to the control stick and rotation of the first link relative to the pitch frame. The lateral axes include a first lateral axis of rotation immediately adjacent to the lower end of the control stick, and a second lateral axis of rotation parallel to, and forward of, the first lateral axis of rotation. The control stick is pivotally mounted to the first link for rotation of the control stick both relative to the first link about the longitudinal axis of the first link member and relative to the first link about the first lateral axis of rotation.

The second coupler, which may be a rigid second link member, includes as a first degree of freedom rotation of the control stick about a longitudinal axis of the second coupler, and includes as a second degree of freedom rotation of the second coupler relative to the post of the base frame about a lateral axis of the second coupler. The second link may include a pivotable first joint at a forward end thereof adapted to provide the rotation of the control stick about the longitudinal axis of the second link. The second link may include a pivotable second joint at a rearward end thereof adapted to provide the rotation of the link relative to the post on the base frame.

The first link may include a pivotable first joint at a rearward end thereof adapted to provide the rotation of the control stick relative to the first link about the longitudinal axis of the first link member. The first link may include a pivotable second joint at the rearward end thereof adapted to provide the rotation of the control stick relative to the first link member about the first lateral axis of rotation. The first link member includes a pivotable third joint at a forward end thereof adapted to provide the rotation of the first link member relative to the pitch frame about the second lateral axis of rotation.

The flight simulator may further include a weight arm having a weighted end which is selectively adjustable mounted to the aft end of the pitch frame for adjustable movement of the weighted end fore or aft relative to the pitch frame so as to selectively adjust a level trimmed and balanced portion of the pitch frame.

The weight arm may be telescopically mounted to the aft end of the pitch frame for telescopic selective adjustment of a longitudinal distance between the weighted end and a balance point of the pitch frame when the pilot is sitting in the seat. The weight arm may be substantially u-shaped arm having distal ends telescopically mated with corresponding rearmost ends of the second part of the rails. A weight may be mounted on a cross member of the u-shaped arm between the distal ends.

### BRIEF DESCRIPTION OF THE DRAWINGS

With reference to the drawings wherein similar characters of reference denote corresponding parts in each view:

FIG. 1 is, in right side upper perspective view, a flight motion simulator apparatus according to one embodiment to the present invention.

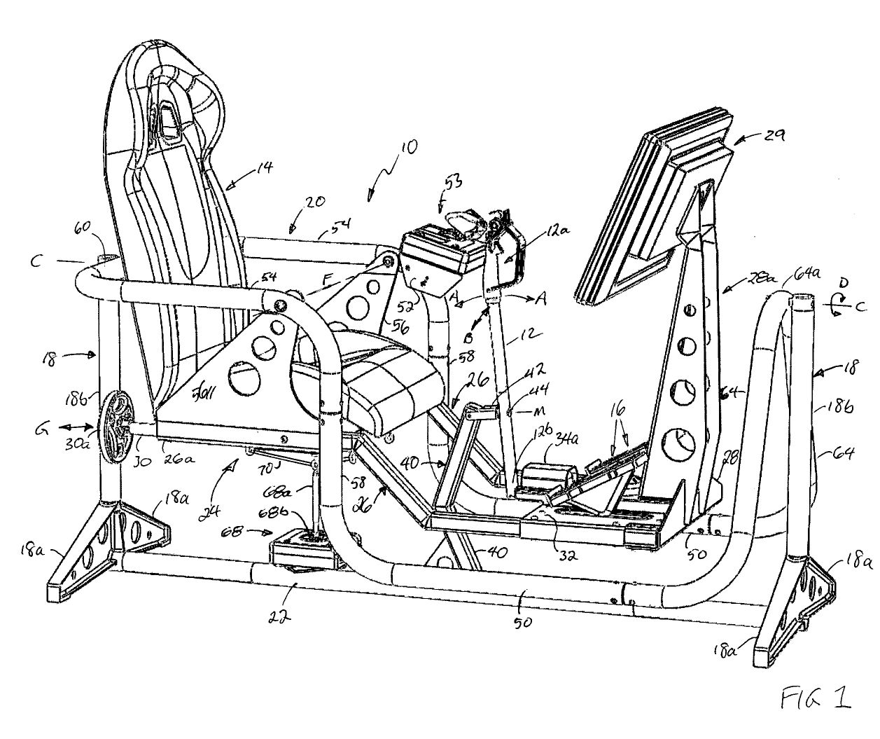

FIG. 2 is, in right side upper perspective view, the flight motion simulator of FIG. 1 with the seat and pivot frames removed.

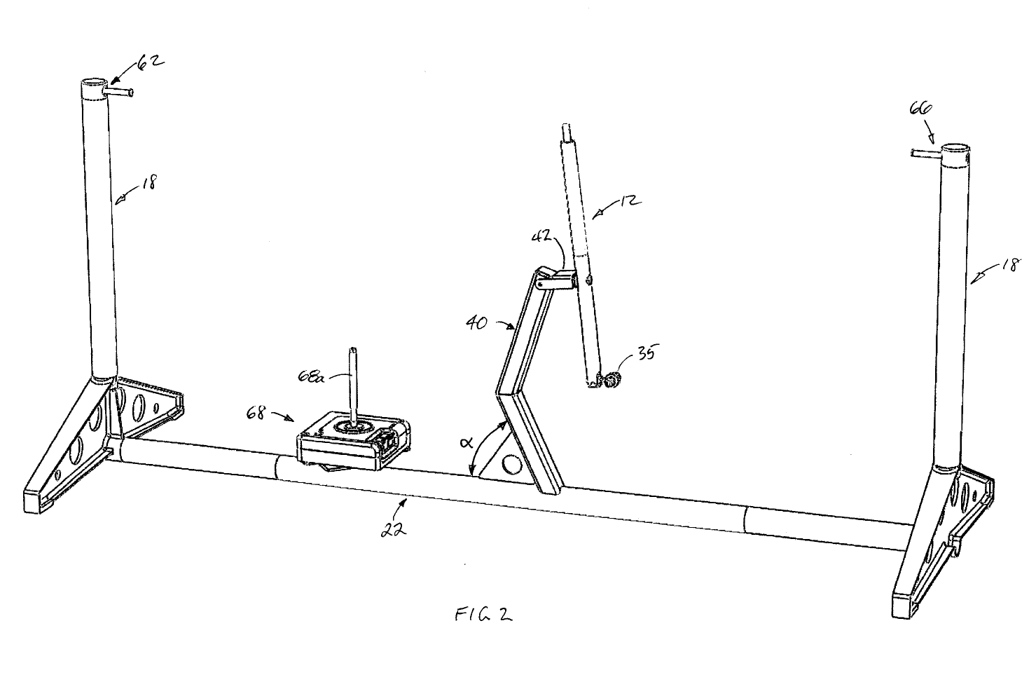

FIG. 3 is the view of FIG. 2 with the roll frame mounted on the base frame.

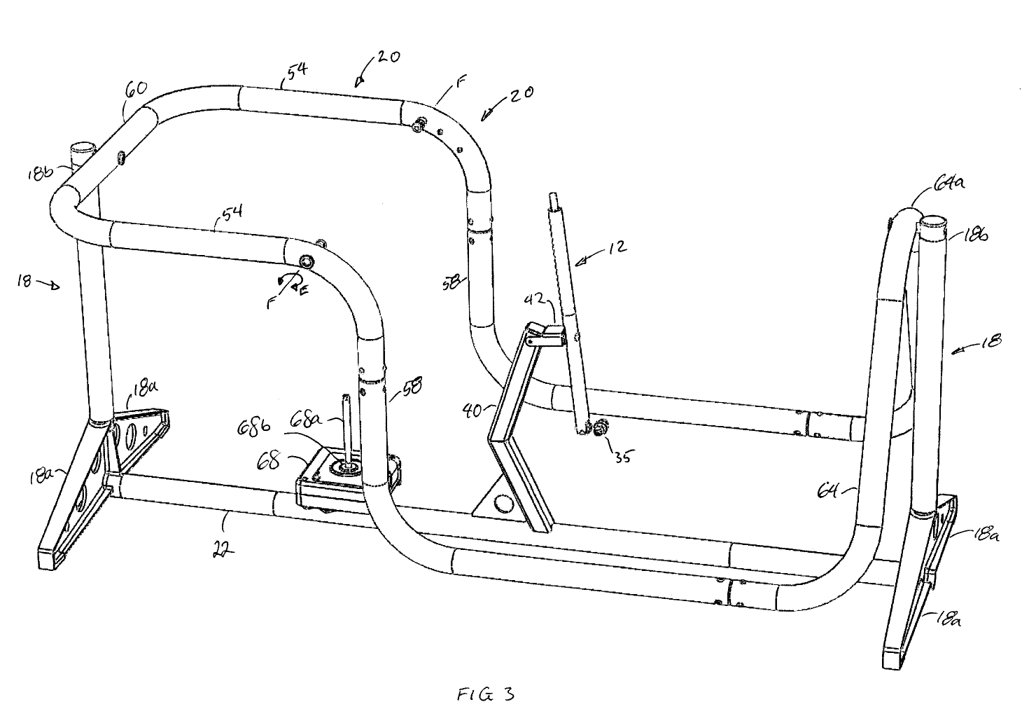

FIG. 4 is the view of FIG. 3 with the pitch frame mounted on the roll frame.

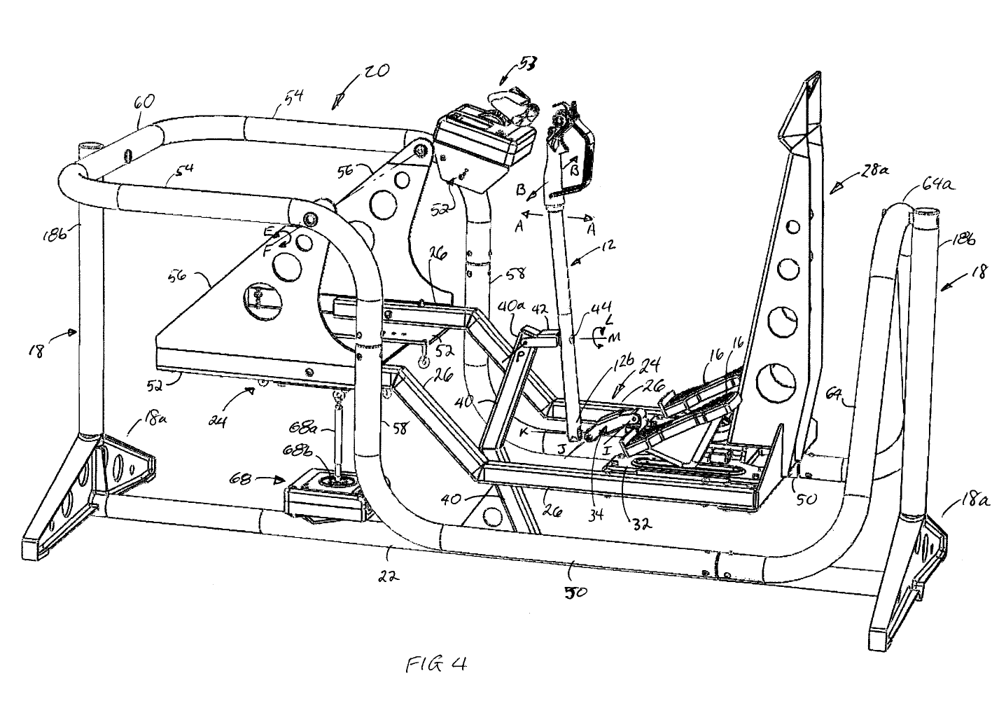

FIG. 5 is an enlarged view of the control stick and control linkages of FIG. 4.

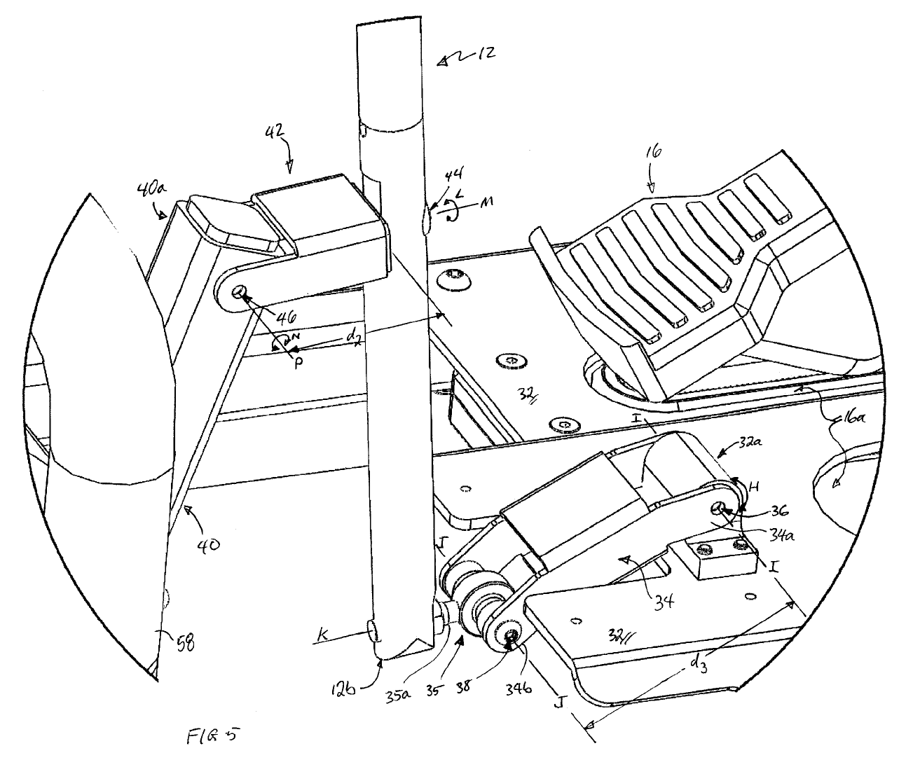

FIG. 6 is in right side elevation view, the flight motion simulator of FIG. 1.

FIG. 6a is the view of FIG. 6 showing dimensions d₁-d₁₀ and the corresponding dimension lines.

FIG. 7 is in bottom perspective view the seat bottom, joystick and its spring attachment to the seat.

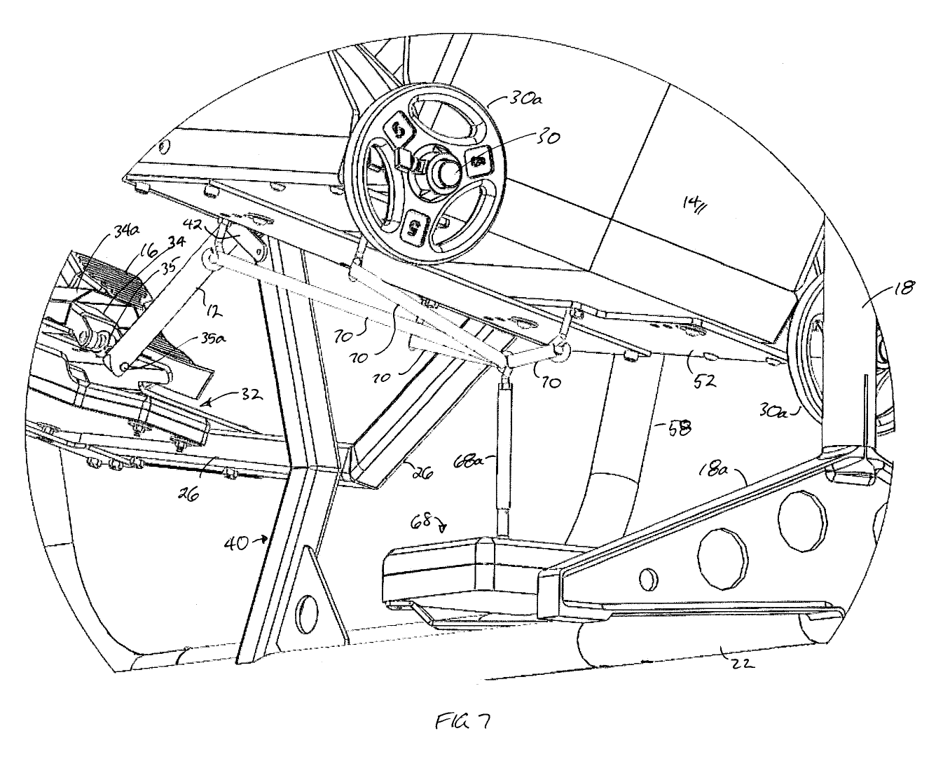

FIG. 8 is the side elevation of FIG. 6 with the pitch frame pitched up.

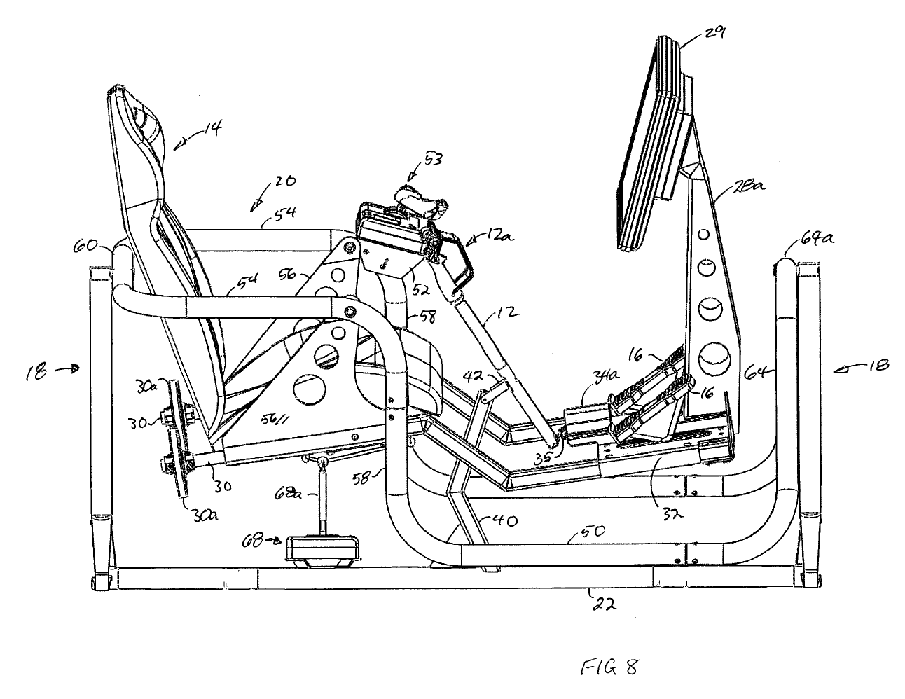

FIG. 9 is in front elevation view, the flight motion simulator of FIG. 1.

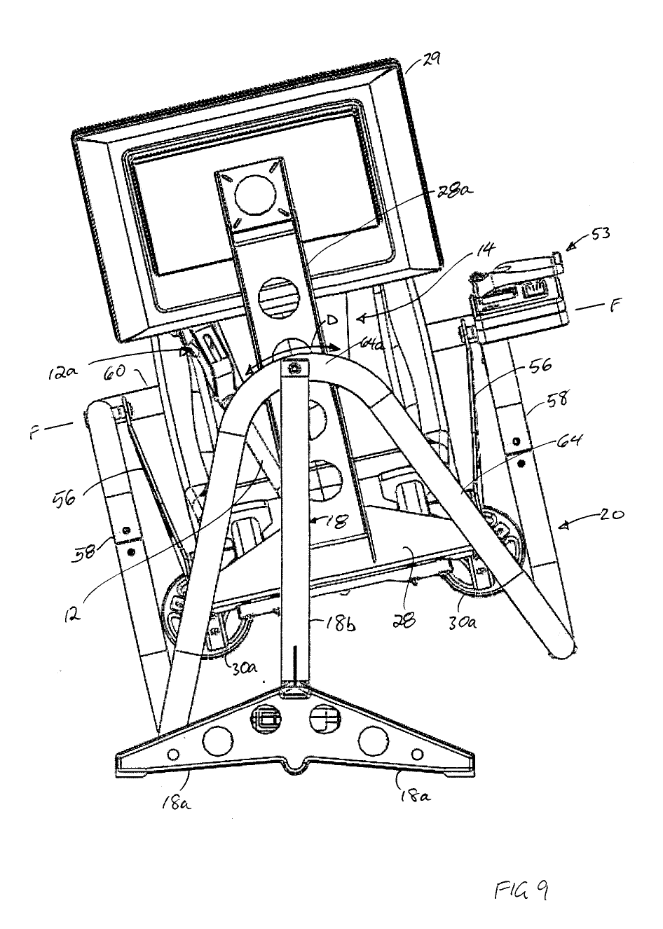

FIG. 10 is a plan view of the flight motion simulator of FIG. 1.

### DETAILED DESCRIPTION OF EMBODIMENTS OF THE INVENTION

The flight simulator apparatus 10 according to one embodiment of the present invention includes a base frame which rests on the ground and supports a gimballed seat carriage which pitches and rolls relative to the base frame by the manual movement by a pilot of a control stick 12. The pilot (not shown) is seated in seat 14 with the pilot's feet placed on control pedals 16 so that control stick 12 extends upwardly between the pilot's knees. A hand grip 12a is mounted on the top end of control stick 12 for grasping by the pilot. Control inputs are inputted by the pilot by movement of the handgrip. Side-to-side movement controls roll, and fore and aft movement controls pitch. That is, moving control stick 12 in direction A controls pitch and movement of control stick 12 to port or starboard in direction B controls roll.

The base frame includes a pair of opposed facing stands 18 each having a pair of oppositely disposed laterally extending legs 18a. A single upright member 18b extends vertically upwardly from each pair of legs 18a.

Roll frame 20 is pivotally mounted at its opposite longitudinal ends to the upper ends of vertical members 18c for rotation of roll frame 20 about roll axis of rotation C in roll direction D. A single rigid longitudinal base stringer 22 is mounted so as to extend linearly between the two stands 18. Stringer 22 may be constructed in sections, such as the three sections illustrated.

A pitch frame 24 is pivotally mounted within roll frame 20 for pitch in direction E about pitch axis of rotation F. Pitch frame 24 includes a substantially parallel pair of longitudinally extending rails 26 which, at their forward ends, are mounted to the lower corners of a substantially triangularly frame member 28. A support column 28a is mounted to and extends vertically upward from frame member 28. A computer flat screen monitor 29 is mounted atop column 28a and oriented so as to be viewable by the pilot sitting in seat 14. When rails 26 are horizontally disposed, that is, when roll frame 20 is level and pitch frame 24 is also level, handgrip 12a and the lower edge of screen 29 lie substantially on roll axis of rotation C and a vertical plane of symmetry containing axis C also contains vertical members 18b, column 28a, control stick 12 and base stringer 22.

Aft frame members 30 are mounted to the rearmost ends 26a of rails 26 so as to extend cantilevered rearwardly therefrom. Weights such as conventional bar bell weights 30a may be slidably mounted onto frame members 30 so that, with for example a 5 pound weight so mounted it may be adjusted in direction G relative to rails 26 to balance pitch frame 24 when a pilot is sitting in seat 14. Thus for a particular weight of pilot, pitch frame 24 may be trimmed to a substantially neutral balance about pitch axis of rotation F to thereby minimize the forces that must be exerted for pitch and roll control by the pilot moving control stick 12 in directions A and B respectively. This increases the apparent sensitivity of the simulated aircraft flight to input controls input by the pilot via handgrip 12a.

The base end 12b of control stick 12 is rotatably coupled to platform 32 by means of link 34. Link 34 may be housed within a protective hollow shell 34a. The forward end 34a of link 34 is formed as a U-shaped collar which is pivotally mounted for rotation in direction H about axis of rotation I and pin 36. Pin 36 protrudes from or is journalled laterally through a block 32a rigidly mounted to platform 32. The opposite end 34b of link 34 is also U-shaped. A shaft 38, bolt or the like is rotatably mounted laterally across the distal ends of end 34b of link 34. A ball-joint or hime-joint 35 mounted to, for relative rotational movement between lower end 12b of stick 12 and shaft 38 provides for rotation about lateral axis of rotation J and about longitudinal axis of rotation K.

An inclined rigid strut or post 40, which may be linear or curved or advantageously dog-leg shaped as illustrated is rigidly mounted at its lower most end to base stringer 22 and is inclined upwardly and forwardly therefrom at an angle. In a preferred embodiment a lower portion, for example the lower half of post 40 is angled rearwardly by an angle X of approximately 60 degrees and the upper portion is angled forwardly by approximately 60 degrees so as to provide a “C”-like shape which gives clearance for rearward movement of lower end 12b of stick 12. This allows for maximum nose-down pitch inputs from the pilot (by pushing handgrip 12a fully forward) while minimizing interference between the stick 12 and the base frame support of post 40. A second link 42 is pivotally mounted between the upper most end 40a of post 40 and control stick 12. Link 42 is rotatably mounted on a pin, shaft or bolt 44 for rotation relative to control stick 12 in direction L about axis M. The aft end of link 42 is rotatably mounted to upper most end 40a of post 40 by pin 46 for rotation of link 42 in direction N about axis P. For sake of certainty, reference herein to aft end is reference to the seat end and reference herein to forward end is reference to the monitor end.

In one preferred embodiment, the distance d, is substantially 7.5 inches. Distance d₁ is, the distance along control stick 12 between shaft 44 and shaft 35a mounting ball joint 35 to end 12b of stick 12. The length d₂ of link 42 is substantially 3 inches. Length d₃ of link 34 is substantially 3.9 inches. The distance d₄, which is the distance from axis M of link 42 along control stick 12 to the base of handgrip 12a is substantially 11 inches. Thus the ratio of d₄:d₁, that is, of the upper length of control stick 12 to the lower length of the control stick on opposite sides of link 42 is substantially 11:7.5 (or 1.47), although a range of other values such as for example the range of 1.3 to 2.0 will also work so long as d₄ is substantially greater than d₁ so as to provide a mechanical advantage for the pilot to actuate movements of the control linkages and pivot frames.

Handgrip 12a may be for example a commercially available flight simulator gaming handgrip sold by Saitek Elektronik Vertriebs GmbH, Landsberger Strasse 400, D-81241 Munich, Germany under the trade name X52 and thus may be itself approximately 6 or 7 inches high. Other commercially available handgrips will work.

Foot pedals 16 may be commercially available flight simulator gaming foot pedals also manufactured by Saitek Elektronik of Munich, German and sold under the trade name Pro Flight Rudder Pedals. Typically foot pedals 16 will be slidably mounted on an attached base. Typically the entire unit including the foot pedals and attached base are sold commercially together. In a preferred embodiment, the base 16a underneath foot pedals 16 is mounted to, for example under, platform 32. A second cross bar 48 is provided mounted underneath the forward end of rails 26 for supporting the underside of the base 16a.

In one preferred embodiment, dimension d₅ is substantially 16 inches, dimension d₆ is substantially 1.4 inches, dimension d₇ is substantially 11.5 inches, dimension d₈ is substantially 12.5 inches, dimension d₉ is substantially 0.25 inches, dimension d₁₀ is substantially 12.6 inches, dimension d₁₁ is substantially 23.3 inches, dimension d₁₉ is substantially 17.75 inches (that is tube 22 is substantially 1.5 inches in diameter and elevated 0.25 inches off the floor) and radius R is substantially 38.6 inches.

Apart from the ratio of d₄:d₁ discussed above, other relevant ratios are as follows, using dimension d₈ as the common denominator:
a) the ratio d₇:d₈ is substantially 11.5:12.5 or 0.9;
b) the ratio d₁:d₈ is substantially 7.5:12.5 or 0.6;
c) the ratio d₅:d₈ is substantially 16:12.5 or 1.3;
d) the ratio R:d₈ is substantially 38.6:12.5 or 3.1.

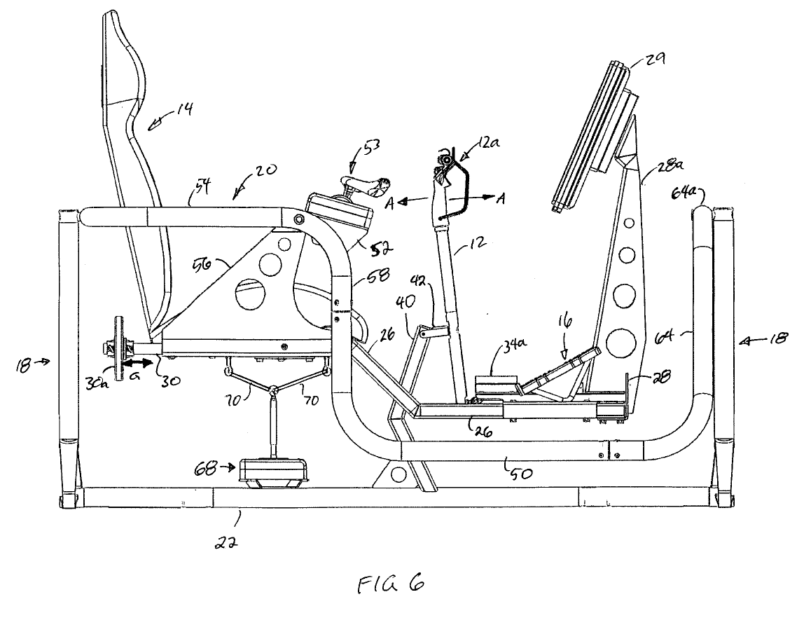

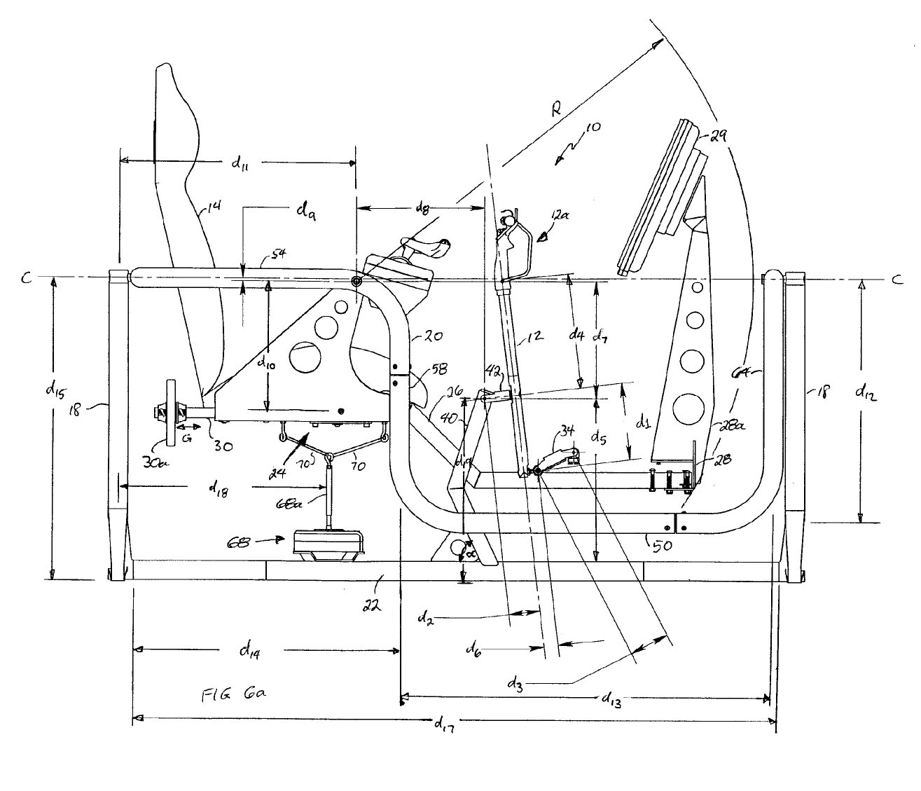

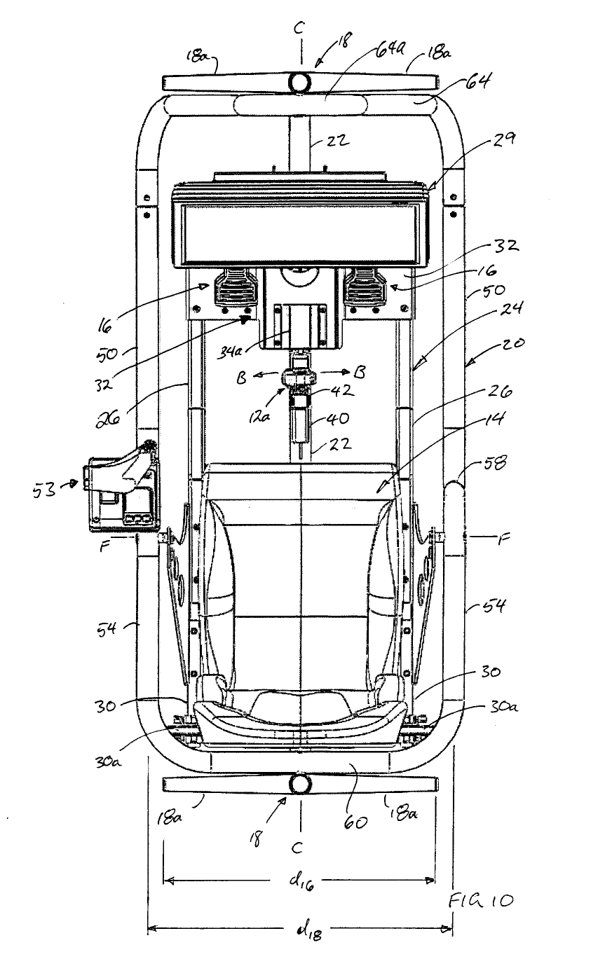

Other ratios are also relevant and can be discerned by a comparison of the enumerated dimensions or those which may be taken by scaling from for example the side elevation and plan views of FIGS. 6a and 10 respectively. It is intended that embodiments incorporating substantial equivalents of the relevant ratios be included within the scope of this specification so that dimensions may be relatively scaled up or down so that the simulator is larger or smaller than the described embodiment so long as it functions in a similar fashion.

In one embodiment, a flexible strap or other forward pitch stop means (not shown) is suspended or mounted as the case may be below and between lower rails 50 of roll frame 20, for example under platform 32 on pitch frame 24. The forward pitch stop means supports the forward end of pitch frame 24 when seat 14 is unoccupied to inhibit the forward end of pitch frame 24 from pitching forwardly to thereby prevent the forward edge of platform 32 from dropping onto base stringer 22.

Seat 14 is rigidly mounted between rear most ends 26a of rails 26 for example by means of supporting rails 52. Although other forms of brackets or supports rigidly mounted between seat 14 and rails 26 would work. Seat 14 and the rear ends of rails 26 of pitch frame 24 are pivotally slung under upper rails 54 of roll frame 20 by means of substantially vertically extending rigid supports 56. Vertical rail sections 58 rigidly connect upper rails 54 to lower rails 50. A cross rail 60 rigidly joins the rearmost ends of upper rails 54 and is rotatably mounted to the rear vertical member 18b by a shaft and bearing coupler 62. A rigid platform or other support 52 may be rigidly mounted from to the port vertical rail section 58 for mounting of a throttle control 53 or other control unit thereon or thereto.

A second triangular frame member 64 is rigidly mounted in a laterally substantially vertical plane across the forward-most ends of rail 50. The vertex 64a of frame member 64 is rotatably mounted to the forward vertical member 18b by shaft and bearing coupler 66.

Triangular frame member 64 is substantially 30 inches across its base. That is, rails 50 are spaced apart at their forward end approximately 30 inches. In one embodiment, triangular frame member 64 is substantially 23¾ inches high measured vertically downwards from vertex 64a (dimension d₁₂). Lower rails 50 are substantially parallel and each are 35⅝ inches long (dimension d₁₃). Vertical rail sections 58 are substantially 23¾ inches long (the same as dimension d₁₂). Upper rails 54 are substantially 25½ inches long (dimension d₁₄). Upper rails 54 are substantially parallel and spaced apart by substantially 29 inches (dimension d₁₈). Each vertical member 18b is substantially 29 17/32 inches high as measured from the floor (dimension d₁₅). The oppositely disposed laterally extending pair of legs 18a may extend substantially 26 inches from end to end (dimension d₁₆) or are otherwise long enough to provide lateral stability. The rear most ends of rails 26 are substantially parallel and spaced apart substantially 21¼ inches so as to support seat 14 therebetween on rails 52 substantially aft of axis F. The length of base stringer 22 spaces vertical members 18b substantially 62 13/16 inches apart as measured longitudinally (dimension d₁₇).

A conventional joy stick controller 68 such as manufactured by Saitek Elektronik of Munich, Germany and sold under the trade name X52, is mounted backwards onto stringer 22 so that the joy stick handle 68a, where it mounts to its base 68b, is approximately 20 23/32 inches forward of the rearmost vertical member 18b (dimension d₁₈). A radially spaced apart array of elongate helical coil springs 70 or other resilient members such as rubber bands are mounted at the center of the radial array to the upper-most end of the joy stick handle 68a. Reference to the joy stick handle is intended to include the rigid shaft which may have been exposed by removing the joy stick handle cover. The distal ends of the individual springs, that is the radially outermost ends of the springs, are mounted spaced around the underside of seat 14, that is, on the underside of the seat portion of seat 14.

The array of springs provide for resilient urging of the joy stick handle 68a as a substitute for a user manually manipulating the handle directly. Movement of the seat provides input to the joy stick via the resilient members 70. The inputs are transmitted to a commercially available flight simulator program loaded and operating in a computer (not shown). The computer program generates an interactive simulated flight of the aircraft on computer monitor 29. Additional side-view monitors (not shown) may be mounted on opposite lateral sides of monitor 29, for example either to opposite sides of column 28a or to opposite sides of frame member 64.

A pilot moving control stick 12 to starboard, that is, to the right, swings the bottom of seat 14 to port, that is, rolls the roll frame so as to move the seat portion of seat 14 to the left thereby imparting a right hand turn input to the joy stick mounted on base stringer 22. Thus, because joy stick 68 is mounted onto base stringer 22 so that the joy stick is oriented backwards, that is, 180 degrees oppositely to how the joy stick would be oriented if the pilot was holding the joy stick in the pilot's lap and controlling the simulated flight by use of the joy stick only, a pilot pulling rearwardly on control stick 12 imparts a forward motion to the seat portion of seat 14 relative to base stringer 22 which then imparts a similar forward motion to the upper most end of the joy stick handle which is interpreted by the joy stick controller as pulling rearwardly on the joy stick. This in turn is interpreted by the flight simulator program as pulling the nose of the aircraft up, that is, pitching the aircraft upwardly. Similarly then, a pilot pushing the control stick forwardly forces the base portion of seat 14 rearwardly imparting a control to the joy stick handle which is interpreted by the flight control program as the joy stick being pushed forwardly resulting in a pitch down input to the simulated aircraft.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A flight motion simulator comprising:
a rigid base frame having upwardly extending, longitudinally opposite fore and aft ends and a base member extending there-between;
a rigid roll frame having opposite fore and aft ends and elevated sides extending there-between wherein said roll frame is rotatably mounted to said fore and aft ends of said base frame for rotation about an elevated longitudinally extending first axis of rotation elevated on upper ends of said longitudinally opposite fore and aft ends of said base frame;
a rigid pitch frame having opposite fore and aft ends and rotatably mounted to said roll frame for rotation about an elevated, laterally extending second axis of rotation on said elevated sides, wherein said first axis of rotation is orthogonal to said second axis of rotation;
whereby said roll frame and pitch frame are rotatable in unison, said roll frame rotatable about said first axis so as to simulate a roll of an aircraft relative to said base frame, and said pitch frame rotatable about said second axis relative to said roll frame so as to simulate a pitch of said aircraft relative to said roll frame;
a seat rigidly mounted to said aft end of said pitch frame so as to face towards said fore end of said pitch frame, said second axis of rotation located adjacent a forward end of said seat and aft of a center of gravity position along a longitudinal length of said pitch frame, a first plane of symmetry coincident with said first axis of rotation and orthogonal to said second axis of rotation, said first plane of symmetry substantially bisecting said seat, said pitch frame and said roll frame;
a rigid post rigidly mounted to and extending upwardly from said base member adjacent and forward of said forward end of said seat and lying substantially in said first plane of symmetry, said second axis of rotation aft of said post;
a rigid control stick having opposite upper and lower ends, a first coupler having at least two degrees of freedom rotatably mounting said lower end of said control stick to said pitch frame and a second coupler also having at least two degrees of freedom rotatably mounting said control stick at a lower mid-section thereof between said upper and lower ends of said control stick to an upper end of said post in said first plane of symmetry, wherein an upper length of said control stick extending from said second coupler to said upper end is longer than a lower length of said control stick extending from said lower mid-section to said lower end so that a first lever arm provided by said upper length of said control stick is longer than a second lever arm provided by said lower length, said upper end of said control stick extending above a lower portion of said seat supporting a posterior of a user sitting in said seat so as to position said upper end of said control stick within reach of the user sitting in said seat and so as to extend between the legs of the user when sitting in said seat, and wherein said at least two degrees of freedom include rotation about a longitudinal axis and about a lateral axis so as to provide for roll and pitch force inputs from the user via the said control stick to said roll frame and said pitch frame respectively;
pitch and roll output means cooperating with said pitch and roll frames for communicating to a flight simulation processor pitch and roll data corresponding to pitch and roll orientation of said pitch and roll frames respectively relative to said base frame.

2. The device of claim 1 further comprising a rigid mount for mounting pedals in said fore end of said pitch frame positioned in said fore end of said pitch frame for placement of the user's feet thereon when the user is sitting in said seat.

3. The device of claim 1 wherein said roll frame includes a spaced apart, longitudinally extending parallel first pair of rails extending along opposite sides of said seat, and wherein said first pair of rails have opposite forward and rearward ends, a forward cross-member extending laterally across and between so as to join said forward ends of said first pair of rails, and a rear cross-member extending laterally across and between so as to join said rearward ends of said first pair of rails, thereby forming a continuous frame defining a cockpit space within which said pitch frame is free to pitch about said second axis, and wherein said first axis intersects said forward and rearward cross-members substantially orthogonally and substantially medially laterally across said cross-members.

4. The device of claim 3 wherein a rearward portion of said first pair of rails form said elevated sides of said roll frame and where a forward portion of said first pair of rails is lower than said rearward portion, and wherein said control stick protrudes upwardly from between said forward portion of said first pair of rails, and wherein said forward cross-member extends upwardly from said forward portion so as to intersect said first axis.

5. The device of claim 4 wherein said fore and aft ends of said base frame include a pair of upstanding elongate support members disposed so that at least upper ends thereof lie in said first plane of symmetry.

6. The device of claim 1 wherein said first coupler is a rigid first link member and wherein a first degree of freedom of said at least two degrees of freedom is said rotation about a longitudinal axis and wherein said longitudinal axis lies in said first plane of symmetry, and wherein a second degree of freedom of said at least two degrees of freedom is said rotation about a lateral axis, and said rotation about a lateral axis includes rotation of said first link relative to said control stick about a first lateral axis of rotation and rotation of said first link relative to said pitch frame, about a second lateral axis of rotation, wherein said first lateral axis is immediately adjacent said lower end of said control stick, and wherein said second lateral axis of rotation is parallel to and forward of said first lateral axis of rotation.

7. The device of claim 6 wherein said control stick is pivotally mounted to said first link for rotation of said control stick both relative to said first link about said longitudinal axis of said first link member and relative to said first link about said first lateral axis of rotation, and wherein said second coupler includes a first degree of freedom of said at least two degrees of freedom and wherein said first degree of freedom of said second coupler provides for rotation of said control stick about a longitudinal axis of said second coupler, and wherein said second coupler includes a second degree of freedom of said at least two degrees of freedom and wherein said second degree of freedom of said second coupler provides for rotation of said second coupler relative to said upper end of said post of said base frame about a lateral axis of said second coupler, and wherein said second coupler is a rigid second link member.

8. The device of claim 7 wherein said second link member includes a pivotable first joint at a forward end thereof adapted to provide said rotation of said control stick about said longitudinal axis of said second coupler, and wherein said second link member includes a pivotable second joint at a rearward end thereof adapted to provide said rotation of said second coupler relative to said upper end of said post, and wherein said first link member includes a pivotable first joint at a rearward end thereof adapted to provide said rotation of said control stick relative to said first link member about said longitudinal axis of said first link member, and wherein said first link member includes a pivotable second joint at said rearward end thereof adapted to provide said rotation of said control stick relative to said first link member about said first lateral axis of rotation, and wherein said first link member includes a pivotable third joint at a forward end thereof adapted to provide said rotation of said first link member relative to said pitch frame about said second lateral axis of rotation.

9. The device of claim 1 further comprising a weight arm for selectively adjustably mounting thereto of a balancing weight, said weight arm mounted to said aft end of said pitch frame for adjustable movement of said balancing weight end fore and aft relative to said pitch frame so as to selectively adjust a level trimmed and balanced position of said pitch frame when the user is sitting in said seat.

10. The device of claim 9 wherein said weight arm is mounted so as to cantilever rearwardly of said aft end of said pitch frame for selective adjustment of a longitudinal distance between said balancing weight when mounted to said weight arm and a balance point of said pitch frame when a user is sitting in said seat.

11. The device of claim 10 wherein said pitch frame includes a spaced apart, longitudinally extending parallel second pair of rails extending along said opposite sides of said seat and pivotally suspended by a pair of rigid laterally spaced apart suspension supports pivotally mounted to and under said rearward portion ends of said first pair of rails for pivoting of said pitch frame about said second axis of rotation.

12. The device of claim 1 wherein said upper length and said lower length of said control stick have a relative length ratio falling in the range of substantially 1.4:1 to 2:1.

13. The device of claim 12 wherein said ratio is substantially 1.5:1.

14. The device of claim 1 wherein said upper end of said post is spaced apart from said second axis by a vertical distance and a horizontal distance and wherein the ratio of said vertical distance to said horizontal distance is substantially 0.9.

15. The device of claim 1 wherein a forward-most end of said pitch frame has a radial distance from said second axis, said radial distance remaining constant as said pitch frame pitches about said second axis, and wherein said upper end of said post is spaced horizontally from said second axis by a horizontal distance, and wherein the ratio of said radial distance to said horizontal distance is substantially 3.

16. The device of claim 14 wherein a forward-most end of said pitch frame has a radial distance from said second axis, said radial distance remaining constant as said pitch frame pitches about said second axis, and wherein said upper end of said post is spaced horizontally from said second axis by a horizontal distance, and wherein the ratio of said radial distance to said horizontal distance is substantially 3.
